(19) United States
(12) Patent Application Publication
(10) Pub. No.: US 2004/0029570 A1
(43) Pub. Date: Feb. 12, 2004

(54) Method and apparatus for electronic payment through mobile communication devices

(75) Inventors: Roger Knorr, Ottmarsheim (DE); Kaspar Dutting, Stuttgart (DE)

Correspondence Address: SUGHRUE MION, PLLC, 2100 Pennsylvania Avenue, NW, Washington, DC, 20037, US

(73) Assignee: ALCATEL

(21) Appl. No.: 10/337,263

(22) Filed: Jan. 7, 2003

(30) Foreign Application Priority Data
Jan. 8, 2002 (EP) 02 360 010.9

(51) Int. Cl. H04M 11/00

(52) U.S. Cl. 455/414.1; 455/406; 455/408

(57) ABSTRACT

The invention relates to a method of transferring electronically stored funds via a communications network with a first mobile user terminal which administers a first account, particularly a prepaid account, for telephone services,

with a central facility in the network which administers a second account. The following steps are carried out:

transferring funds between the first and second accounts and transferring funds to further accounts accessible via the network with the aid of the mobile user terminal, and/or

transferring funds between the second account and

a further account in the network, with the first or second account acting as a proxy for the second or first account, so that the second or first account does not become visible during the transaction.

### BACKGROUND OF THE INVENTION

The invention is based oh a priority application EP 02 360 010.9 which is hereby incorporated by reference.

This invention relates to a method and apparatus for transferring electronically stored funds via a communications network with a mobile user terminal which administers a prepaid account for telephone services.

The increasing mobility of the society creates a constant demand for modes of payment which can be initiated via mobile terminals, such as mobile telephones or PDAs.

Conventional techniques frequently use credit cards. The entry of columns of figures and of prices seems very difficult, particularly in the case of small terminals. Furthermore, the use of credit cards involves a high security risk.

U.S. Pat. No. 5,991,749 discloses a method in which payments are initiated by entering a particular code. The user dials into a central processing unit by entering particular codes, and the CPU is then controlled by entering scan codes, particularly function codes.

U.S. Pat. No. 6,169,890 discloses a method in which a SIM card is used in a GSM network to provide secure communications in an environment demanding high data security. A connection is established which is confirmed, on the one hand, by the SIM card and, on the other hand, by a PIN. After the user has been authenticated, the connection is switched through to a service provider where the transactions can take place.

U.S. Pat. No. 5,915,226 discloses a method in which a credit which is debited on each use is stored on a SIM card. The serial number is set off against a key number. More detailed information can be taken from the patent specification.

### SUMMARY OF THE INVENTION

It is an object of the present invention to provide a method and apparatus which allow transactions to be conducted while ensuring maximum mobility. Not only accounts serving to make telephone calls are to be debited, but also accounts with which payments can be made for consumer goods. Because of the high security standard, however, it is advantageous if existing accounts, particularly on SIM cards, can be incorporated to make payments. Furthermore, it may be advantageous if other accounts are not visible to the recipient, so that the possibility of misuse can be excluded.

This object is attained by the inventions according to the independent claims. Advantageous developments of the inventions are characterized in the subclaims.

An important aspect of the present invention is a method of transferring electronically stored funds via a communications network with a first mobile user terminal which administers a first account, particularly a prepaid account, for telephone services, with a central facility in the network which administers a second account, a transfer of funds being possible between the two accounts and from at least one account to further accounts accessible via the network with the aid of the mobile user terminal. Through this approach it is possible that only the prepaid account, which is administered either directly on the mobile terminal or centrally, is used for payments. This account is loaded as required and can thus be used to pay for consumer goods and for telephone services. One possibility is to store the funds on the card in encrypted form using known encryption techniques. As transactions are possible between the individual accounts, it can be ensured that only necessary amounts are available on the mobile terminal. If a greater amount should be needed, it can be loaded shortly before the transaction and then be forwarded. Through the assignment of two accounts to a mobile terminal, the security measures that are used for the known SIM account can also be applied to the second network account. This makes it possible to use a single login to administer both accounts. Furthermore, one security concept, such as transaction numbers, can be used for both accounts. The central account can be addressed like a conventional bank account from outside by remittances, so that it can be replenished at any time. The central account serves as an interface to normal bank accounts. The account on the mobile terminal serves to pay for consumer goods or telephone services, which can be done without use of cash at any time. Through the separation of the two accounts, security is greatly increased. If the telephone should be lost, only the funds stored directly on the telephone will be lost, not the funds on the account behind it. Thus, the nontransparent proxy function of the mobile account can avoid the loss of large amounts of money. If the mobile terminal should be lost, both accounts can be deactivated by a single stop. Through the close connection between the two accounts, the security standard and the trust relationships can be easily transferred.

In a preferred embodiment, the transfer of funds takes place nontransparently in the background, using the account on the mobile terminal as a proxy account. Payments are made via this account, with funds being automatically debited from the central account or a check being made as to whether a credit can be allowed.

The terminal or the central server memorize frequently conducted transactions that are offered to the user without a host of data having to be entered. This enables the user to use macros with which he or she can control the transactions between the accounts. Transactions are initiated by instructions from the user terminal, with macros, in particular, being used to start frequently occurring transactions in a simple manner.

To permit proxy transactions, two or more transactions are encapsulated into a single transaction. For a remittance via the account of the mobile terminal, for example, a first transaction is executed which transfers funds in real time to the central account, from which these funds are then sent to the destination account. If a real-time transaction should not be possible, a credit will be requested. This is possible since there is a trust relationship between the two accounts. Only at a later time will the funds be actually transferred.

To prevent the loss of the terminal from resulting in major damage, a password may be additionally required to gain access to the central account. It is also conceivable that after a given time, the user is logged out automatically. In addition, it is conceivable to use TANs. Communication between the two accounts takes place in encrypted form, preferably using an asymmetric or symmetric technique, with the respective keys being automatically exchanged from time to time because of the trust relationship. It is also possible that the encryption takes place on the basis of the SIM.

In a preferred embodiment, the network is a telephone network as is used to provide telephone service to mobile subscribers (GSM, UMTS). It is also possible, however, that the information is exchanged via the Internet, with the central server making available a dedicated account. In view of the integration of data and telephone networks, such integration is to be expected in the near future. In that case, SSL can be used for the encryption, with the trust relationships being represented by certificates.

Another part of the present invention is a user terminal, particularly a mobile terminal, which administers the first account, with the funds of the first account being administered on the user terminal itself or on a node in the network. It should be pointed out that it is immaterial whether the funds are administered on the mobile telephone itself or on a corresponding account. What is important is that between the first and the second account, there is a trust relationship which is implemented by suitable security mechanisms. This trust relationship, as described above, may be established by certificates, keys, or particular identification parameters. Furthermore, the terminal comprises the capability to administer the accounts in such a way that one of the two accounts is used as a proxy account. The detailed method was already described above. In a preferred embodiment, the prepaid account of a telephone can be used to temporarily store amounts of money on the terminal.

A further part of the present invention is a software which implements the functionality of the method on an arbitrary terminal. This is particularly important if terminals are equipped like small PCs. Currently available handhelds already have large amounts of storage (64 MB). For such terminals it is readily possible to implement the corresponding functionality by software that runs in the background.

The software provides interfaces which permit the exchange of credits with other accounts in the network. It has a functionality which makes the first or second account appear as a proxy account for a second or first account, so that in a transaction involving other accounts, the second or first account will not become visible. Furthermore, the software can store funds in encrypted form, so that access from outside is not possible. It is even conceivable to store the funds on the telephone card of the terminal, so that battery- and supply-voltage fluctuations will remain without consequences. Depending on the structure of the prepaid card, the account can be represented on the latter.

### BRIEF DESCRIPTION OF THE DRAWINGS

The invention will become more apparent from the following description of embodiments when taken in conjunction with the accompanying schematic drawings. Like reference numerals have been used to designate like elements throughout the various figures. In the drawings:

FIG. 1 shows a network with a mobile user having a first account, with a second account in the network, and a third account which serves as a destination account for possible transactions; and

FIG. 2 shows an alternative embodiment in which the first account is administered directly on the terminal.

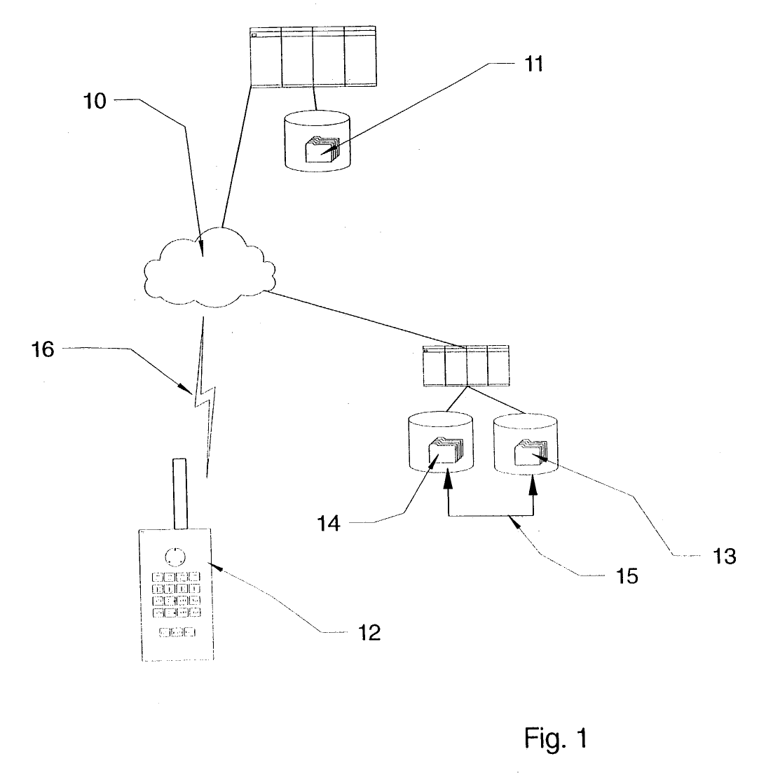

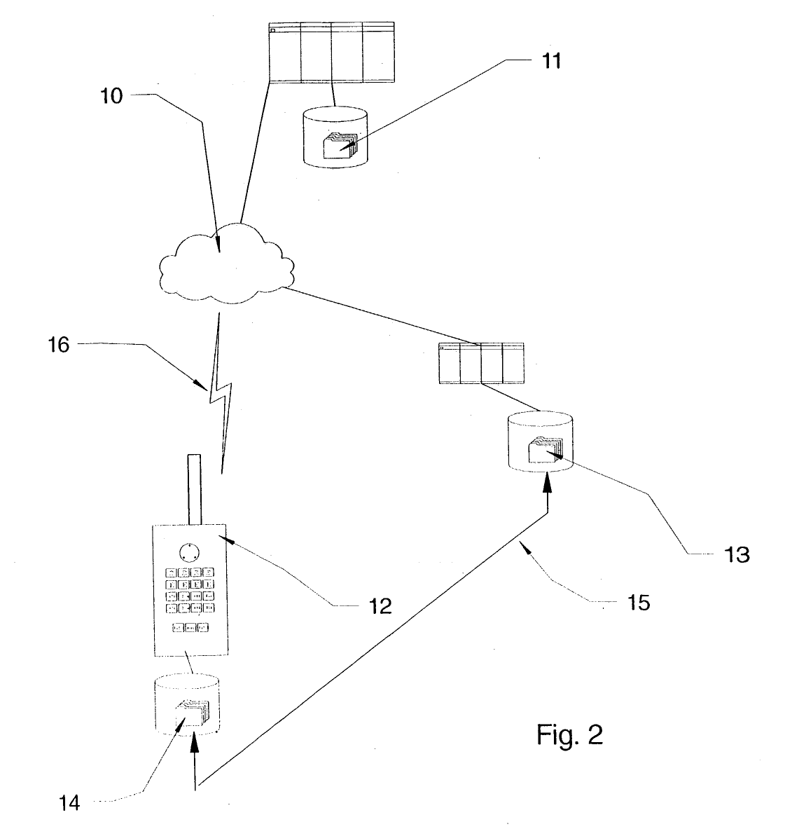

FIG. 1 shows a network 10 having a first server connected thereto, which administers two accounts 14 and 13 between which there is a trust relationship 15. The network is also connected to a mobile terminal 12 by a wireless link 16. A third account 11 is connected via the network, so that transactions can be conducted between accounts 14, 13, and 11 in the manner described above. In FIG. 1, unlike in FIG. 2, the prepaid account 14 is also located centrally. As a result, security is substantially increased, so that any loss of terminal 12 cannot result in a loss of funds. In FIG. 2, the account is administered on the mobile terminal. This is done using conventional encryption techniques.

1. A method of transferring electronically stored funds via a communications network with a first mobile user terminal which administers a first account, particularly a prepaid account, for telephone services,
with a central facility in the network which administers a second account, wherein the steps of:
transferring funds between the first and second accounts and transferring funds to further accounts accessible via the network with the aid of the mobile user terminal, and/or
transferring funds between the second account and a further account in the network, with the first or second account acting as a proxy for the second or first account, so that the second or first account does not become visible during the transaction.

2. A method as set forth in claim 1, wherein the transactions are initiated by instructions from the user terminal, using macros in particular to start frequently occurring transactions in a simple manner.

3. A method as set forth in claim 1, wherein the transactions are encapsulated by carrying out two transactions, with the first transaction transferring funds from the second account to the first, from which the funds are then transferred to the destination account,
or
after checking the second account, by granting to the first account a credit which is balanced via the second account at a later time.

4. A method as set forth in claim 1, wherein communication takes place in encrypted form, and that the transactions are secured with a password and/or a transaction number.

5. A method as set forth in claim 1, wherein the network is a telephone network or the Internet.

6. A user terminal, particularly a mobile terminal, in a network which administers a first account, with the funds of the first account being administered on the user terminal itself or by a node in the network, wherein means which permit an exchange of funds between the first account and a second account in the network,
and/or
by means which make the first or second account appear as a proxy account for the second or first account, so that the second or first account does not become visible during the transaction.

7. A user terminal as set forth in the preceding claim, wherein in order to implement the proxy function, two transactions are carried out, with the first transaction transferring funds from the second account to the first, from which the funds are then transferred to the destination account,
and/or
after checking the second account, the first account is granted a credit which is balanced via the second account at a later date.

8. A user terminal as set forth in claim 6, wherein prepaid telephone cards are used for the account.

9. Software for a mobile terminal in a network which administers a first account, with funds being stored on the mobile terminal or by a central node in the network, the software providing interfaces which permit an exchange of funds with other accounts in the network, and having a functionality which makes the first or second account appear as a proxy account for a second or first account, so that the second or first account does not become visible during a transaction with other accounts.

10. Software as set forth in the preceding claim, wherein the account is represented on the basis of a prepaid card.
